(19) United States
(12) Patent Application Publication
(10) Pub. No.: US 2003/0232537 A1
(43) Pub. Date: Dec. 18, 2003

(54) AC power adapter enhancement device and system

(76) Inventor: Christopher Caporicci, Norfolk, VA (US)

Correspondence Address: Trevor Coddington, 1900 K STREET, N.W., Washington, DC, 20006-1109, US

(21) Appl. No.: 10/167,509

(22) Filed: Jun. 13, 2002

(51) Int. Cl. H01R 9/05

(52) U.S. Cl. 439/578

(57) ABSTRACT

An adapter enhancement for an AC adapter is disclosed. According to one embodiment of the invention, the adapter enhancement includes two concentric conducting cylinders affixed to and insulated by a ring shaped insulator at one end or both ends. The adapter enhancement is placed in between an AC adapter an electronic device. In this manner, an outer wall of the outer conducting cylinder contacts an outer electrical contact of an electronic device while an inner wall of the outer conducting cylinder contacts the outer electrical contact of the AC adapter. Similarly, an outer wall of the inner conducting cylinder contacts the inner electrical contact of an AC adapter while the inner wall of the inner conducting cylinder contacts the inner contact of the electronic device. As such, the adapter enhancement provides a more secure fit between the AC adapter and the electronic device.

### 1. FIELD OF THE INVENTION

The present invention relates to electrical power supply, particularly, a device and system for improving the electrical contact between an electronic component and an AC power supply adapter.

### 2. DESCRIPTION OF THE RELATED ART

Many electronic devices, e.g., laptop computer, compact disc (CD) player, etc., are configured to receive electrical power from an external source via an alternating current (AC) adapter. An AC adapter allows an electrical device to acquire electrical power distributed from an external source via an electrical outlet, such as a home wall outlet or car cigarette lighter. Often, in addition to serving as a medium for carrying electricity from the source to the device, an AC adapter transforms the external power and current levels to suitable operational levels of that device. For example, an AC adapter for a laptop computer is likely to be configured to transform a high voltage and low current source in the United States or Europe, e.g., 100-240 V and 0.95-0.55 A at 50-60 Hz, to a lower voltage and higher current, such as 15 V at 3 A. Generally, the AC adapter provides alternating current to the electronic device, which converts the alternating current to direct current (DC) for the charging of batteries when batteries are present in the device and/or to operate the device when internal batteries are low, do not exist, or are not required.

FIGS. 1A-B illustrate side and end views of a conventional AC adapter system 100 with an exemplary configuration to electrically link an electronic device 120 via an AC adapter 140 to an external power outlet 150. Electronic device 120 comprises an electrical port 122 having an outer electrical contact 124 and inner male electrical contact 126. AC adapter 140 comprises a device end 142 and a power outlet end 149. Device end 142 comprises an outer electrical contact 144, an inner female electrical contact 146, and an insulator 148. Insulator 148 electrically insulates contacts 144 and 146 from one another and also provides physical support. As shown, power outlet end 149 is a two (2) prong connector for connecting AC adapter 140 into power outlet 150. However, power outlet end 149 can be configured as a three (3) prong connector, a car cigarette lighter connector, or any other type of conventional connector or plug necessary for acquiring electricity from an electrical source or electrical power outlet. In operation, power outlet end 149 is connected to power outlet 150. To facilitate electrical power to be acquired by device 120, device end 142 of AC adapter 140 is inserted into electrical port 122 so that device contacts 124 and 126 make electrical contact with respective adapter contacts 144 and 146. Generally, when electrical power from outlet 140 is no longer needed by device 120, device end 142 of AC adapter 140 is disconnected from electrical port 122 and/or power outlet end 149 is disconnected form outlet 150.

Optimum performance of device 120 generally occurs when device end 142 of AC adapter 140 snuggly fits into electrical port 122, thereby securing electrical contact between all appropriate electrical contacts in the device and AC adapter. However, the repeated steps of connecting and disconnected device end 142 to electrical port 122 are likely to result in physical wear or damage to one or more of the components. For example, wear or damage can occur to device contacts 124 and/or 126, adapter contacts 144 and/or 146, insulator 148, or any combination thereof can result. Wear and damage also tends to occur more rapidly in portable electronic devices, e.g., auto plugs, laptop computers, portable CD players, etc. where movement is involved. In such a situation, device end 142 is not likely to securely fit again into electrical port 122, thereby leading to bad electrical contact between one or more of the appropriate electrical contacts in the device and AC adapter and subsequently, causing improper operation of device 120.

### SUMMARY OF THE INVENTION

Therefore, a need has arisen for improving the electrical contact between an electrical device and AC adapter. It is an object of the invention to provide an AC power adapter enhancement device and method for improving and securing the electrical contact of an AC adapter inserted into an electrical input port of an electrical device.

According to an embodiment of the invention, an electrical power adapter enhancement comprises a first conductor, a second conductor enclosing a portion of the first conductor, and a first insulator affixed to the first and second conductors, wherein the first insulator comprises an opening having an inner surface, the first conductor being affixed to the inner surface of the opening of the first insulator. The first conductor comprises an inner surface adapted to contact a first electrical contact of an electronic device and an outer surface adapted to contact a first electrical contact of an AC adapter. The second conductor comprises an inner surface adapted to contact a second electrical contact of the AC adapter and an outer surface adapted to contact a second electrical contact of the electronic device. The first and second conductors can be cylindrically shaped and coaxial. An optional second insulator can be affixed to said second conductor.

In another embodiment of the invention, an electrical connector comprises a first insulator, wherein the first insulator is substantially ring shaped and comprises an inner circumferential surface and an outer circumferential surface; an inner substantially cylindrical conductor, wherein an outer surface of the inner conductor is affixed to the inner circumferential surface of the first insulator; and an outer substantially cylindrical conductor, wherein an inner surface of the outer conductor is affixed to the outer circumferential surface of the first insulator. The electrical connector can further comprise a second insulator, wherein the second insulator is substantially ring shaped and comprises an opening having an inner surface affixed to the outer surface of the outer conductor. Moreover, a lever can be connected to one or more segmented portions of the outer conductor. The lever can be positioned into a locked position forcing the one or more segmented portions of the outer conductor toward a cylindrical axis.

In another embodiment of the invention, a method comprises the steps of: placing an adapter enhancement over an electrical device end of an AC adapter; and inserting the AC adapter electrical device end with the adapter enhancement into an electrical port of an electrical device. The adapter enhancement can be locked into the electrical port by positioning a lever affixed to the adapter enhancement into a locked position.

An advantage of the invention is that it provides a secure electrical contact between an AC adapter and an electronic device, thereby avoiding improper operation of the electronic device caused by worn or damaged electrical contacts. Another advantage is that the invention prevents further damage to the electrical port of an electronic device or the device end of the AC adapter.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1A illustrates a conventional AC adapter system;

FIG. 1B illustrates an end view of an electronic device and an AC adapter in the system illustrated in FIG. 1A;

FIG. 2A illustrates an AC adapter enhancement according to an embodiment of the invention;

FIG. 2B illustrates an end view of the AC adapter enhancement illustrated in FIG. 2A;

FIG. 3 illustrates an AC adapter enhancement system according to an embodiment of the invention;

FIG. 4 illustrates an AC adapter enhancement according to another embodiment of the invention; and

FIGS. 5A-D illustrate top, side, and end views of two versions of an AC adapter according to an embodiment of the invention.

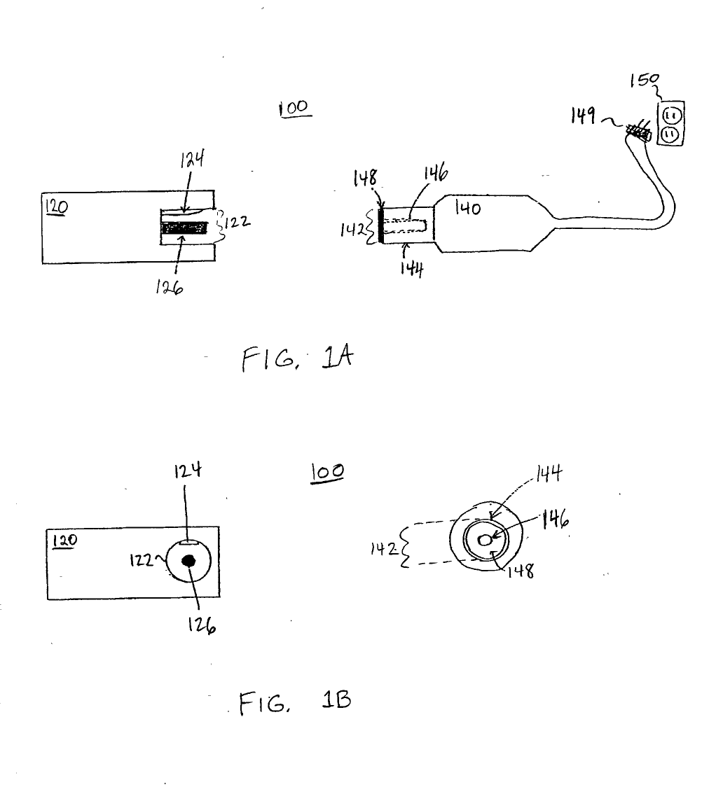

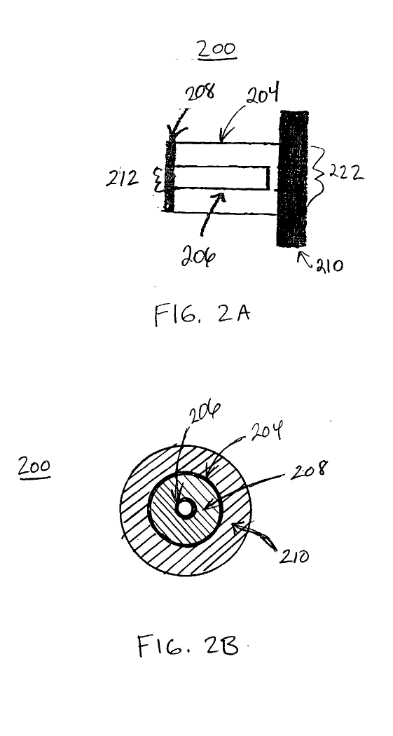

### DETAILED DESCRIPTION OF PREFERRED EMBODIMENTS

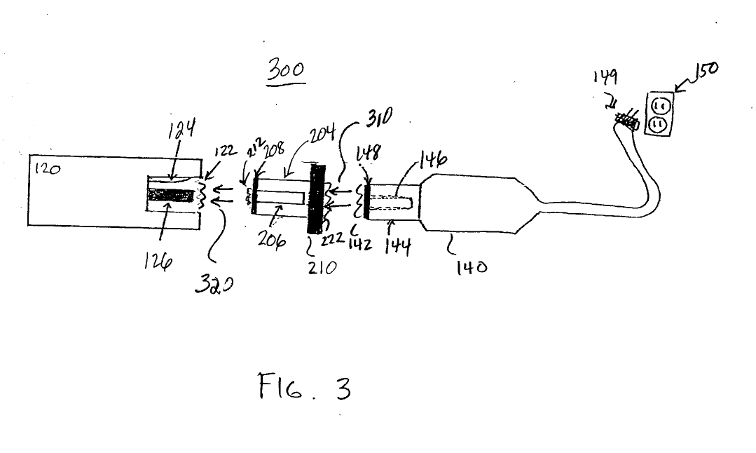

Preferred embodiments of the present invention and their advantages may be understood by referring to FIGS. 2-5, wherein like reference numbers indicate like elements and the left most digit(s) of each reference number corresponds to the figure in which the reference number is first used. These preferred embodiments are discussed in the context of securing an electrical connection between an electronic device and a corresponding AC adapter. Nevertheless, the inventive concept can be adapted to secure electrical contact between electrical components in general.

FIGS. 2A-B illustrate side and end views of an adapter enhancement 200 according to an embodiment of the invention. Adapter enhancement 200 comprises an outer electrical conductor 204, an inner electrical conductor 206, a first insulator 208, and an optional second insulator 210. Conductors 204 and 206 are insulated from each other and supported by insulator 208. In a preferred embodiment of the invention, insulators 208 and 210 are substantially ring shaped disks encircling respective openings 212 and 222, and conductors 204 and 206 are cylindrically shaped. Conductor 204 is affixed to an outer circumference of insulator 208 and inner circumference of ring 210 encircling opening 222. Conductor 206 is affixed to an inner circumference of insulator 208. As shown, conductor 206 is not affixed to insulator 210 and is shorter than conductor 204. In other embodiments, conductor 206 can be longer than or substantially equal to the length of conductor 204, and optionally affixed to insulator 210.

FIG. 3 illustrates an adapter enhancement system 300 comprising adapter enhancement 200 for securing the connection between electronic device 120 and AC adapter 140. In operation, adapter enhancement 200 is placed in between device 120 and AC adapter 140. As depicted by arrows 310, device end 142 of AC adapter 140 is inserted into opening 222 of adapter enhancement 200. Preferably but not necessary, AC adapter 140 is inserted into adapter enhancement 200 so that insulators 148 and 208 are brought into contact with one another. Friction between the surfaces of device end 142 and adapter enhancement 200 provides for a secure connection. As such, the outer wall of adapter contact 144 is brought into electrical contact with an inner wall of conductor 204. Likewise, an outer wall of conductor 206 is brought into electrical contact with an inner wall of adapter contact 146. In similar fashion as depicted by arrows 320, the end of adapter enhancement 200 with opening 212 is inserted into the opening of electrical port 122 such that an outer wall of device contact 126 penetrates opening 212 and makes electrical contact with an inner wall of conductor 206, and an outer wall of conductor 204 makes electrical contact with contact 124.

Insulator 210 prevents adapter enhancement 200 from being inserted too far into electrical port 122 and prevents the possibility of adapter enhancement 200 being lodged and/or causing damage to electrical port 122. In a preferred embodiment of the invention, insulator 210 is flanged enough to prevent being lodged in electrical port 122. For example, the flange provides a means to grasp adapter enhancement 200, thereby aiding in its removal if it should stay inside the electronic device 120 when disconnecting AC adapter 140. The flange of insulator 210 is preferably small enough to prevent interference with various designs of electronic devices 120 and designed to fit between various geometric configurations of electronic devices 120 and AC adapter 140.

Adapter enhancement 200 is configured to tightly slide over AC adapter 140, thereby providing a secure connection between a damaged device end 142 of AC adapter 140 and/or a damaged electrical port 122 of electronic device 120. However, neither device end 142 of AC adapter 140 nor the electrical port 122 of electronic device 120 requires damage for adapter enhancement 200 to be implemented in between. For example, adapter enhancement 200 can be implemented between an undamaged device end 142 and undamaged electrical port 122, thereby providing a more secure connection between or preventing damage and wear to device end 142 and electrical port 122.

Preferably, conductors 204 and 206 are metal or other suitable electrical conducting material, and insulators 208 and 210 are plastic or other suitable electrically insulating material. Particular dimensions and shapes of conductors 204 and 206, and/or inductors 208 and 210 may vary depending on the configurations of electrical port 122 and AC adapter 140. For example, insulators 208 and 210 can be non-circular, e.g., substantially rectangular, and conductors 204 and 206 noncylindrical and not coaxial. The geometric configurations of the embodiments described herein are exemplary only. Adapter enhancement 200 can be adapted to facilitate the electrical connection between any type of conventional or foreseeable connection configuration between an electrical device and a detachable electrical power cord or adapter.

Electrical port 122 device contact 124 is typically flexible and tends to tarnish overtime due to its metal composition. The tarnishing along with repeated plugging and unplugging, and movement of electronic device 120 loosens the pressure that device contact 124 exerts against an AC adapter plug. Device contact generally 124 flexes and provides pressure against device end 142. Adapter enhancement 200 increases contact pressure between AC adapter device end 142 and device contact 124 after this pressure has been decreased to an unsuitable level.

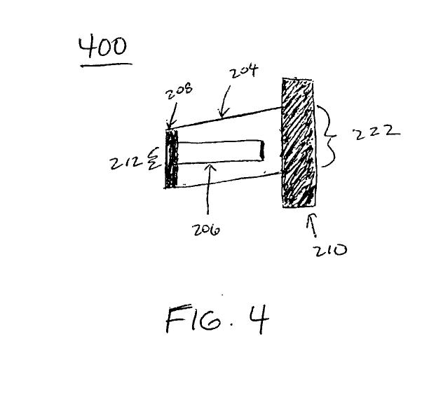

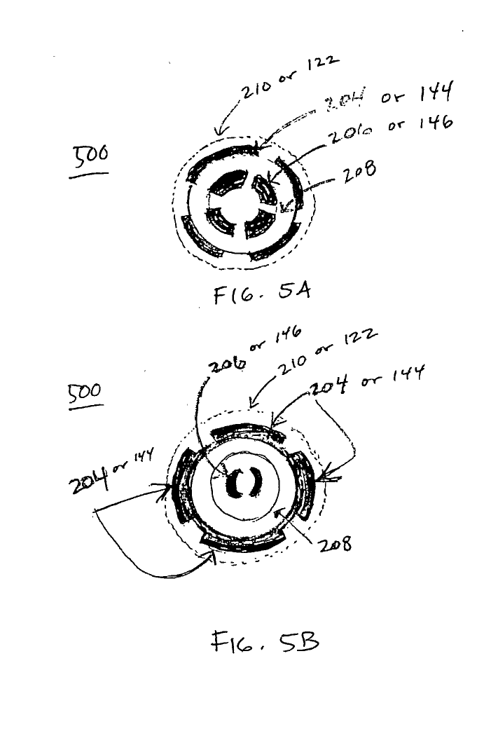

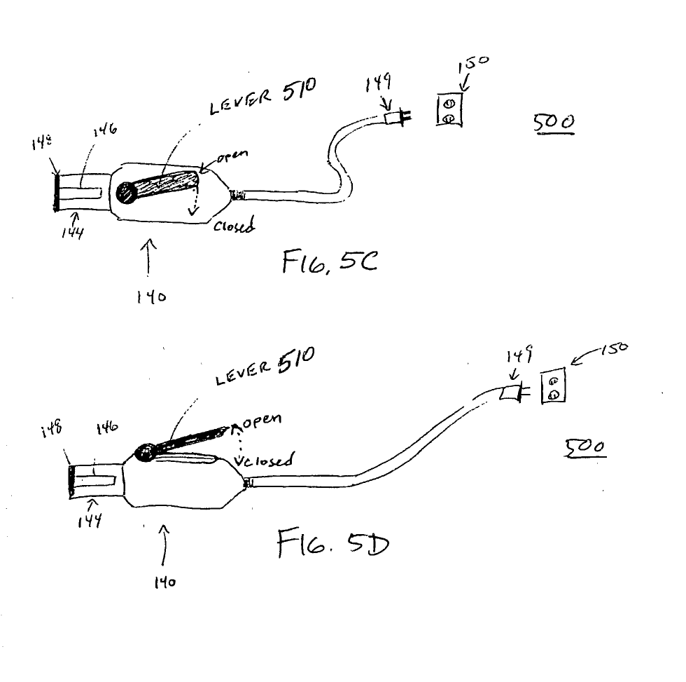

FIG. 4 illustrates an adapter enhancement 400 according to another embodiment of the invention. Similar to adapter enhancement 200, adapter enhancement 400 comprises an outer electrical conductor 204, an inner electrical conductor 206, an insulator 208, and an optional insulator 210. Moreover, insulators 208 and 210 are preferably substantially ring shaped disks encircling respective openings 212 and 222, and conductors 204 and 206 are cylindrically shaped. However, in the present embodiment, conductors 204 and 206 are not coaxial, but slightly off axis, i.e., not parallel with each other. The figure is exaggerated to illustrate the concept better. Because of the offset design of adapter enhancement 400, more pressure is applied between outer contact 204 and device contact 124 as well as inner contact 206 and device contact 126.

FIGS. 5A-D illustrate two versions of an AC adapter or 500 according to an embodiment of the invention. AC adapter 500 is a complete replacement solution for conventional AC adapters. Nevertheless, the inventive concept can also be employed by adapter enhancements 200 and 400. Particularly, AC adapter 500 comprises outer contact 144 or 204, which move outward and inward in a radial direction when a lever 510 is respectively moved between an opened and closed position. For example, when placed in the closed position, lever 510 exerts pressure on outer contact 144 or 204, thereby compress a portion of contact 144 or 204 inward toward the center axis. The closed (locked) position provides secure contact between outer contact 144 or 204 and device contact 124 as well as secure contract between inner contact 146 or 206 and contact 126 in electrical port 120.

In a preferred embodiment of the invention, outer contact 144 or 204 are segmented into a number of portions when combined comprise a cylindrically shaped object. For example, as shown, outer contact 144 or 204 are segmented into four equal portions running along a hypothetical cylinder. In between adjacent portions is a space. However, when outer contact 144 or 204 is compressed via lever 510, the segmented portions are drawn toward and can contract each other. Likewise, inner contact 146 or 206 can be segmented into a number of portions, e.g., two (2) or four (4) as displayed.

Although the invention has been particularly shown and described with reference to several preferred embodiments thereof, it will be understood by those skilled in the art that various changes in form and details may be made therein without departing from the spirit and scope of the invention as defined in the appended claims.

I claim:

1. An electrical power adapter enhancement comprising:
a first conductor;
a second conductor enclosing a portion of said first conductor; and
a first insulator affixed to first and second conductors, wherein said first insulator comprises an opening having an inner surface, said first conductor being affixed to said inner surface of said opening of said first insulator.

2. The adapter enhancement of claim 1, wherein
said first conductor comprises
an inner surface adapted to contact a first electrical contact of an electronic device and
an outer surface adapted to contact a first electrical contact of an AC adapter,
said second conductor comprises
an inner surface adapted to contact a second electrical contact of said AC adapter and
an outer surface adapted to contact a second electrical contact of said electronic device, and
said adapter enhancement providing a secure electrical connection between said electronic device and said AC adapter.

3. The adapter enhancement of claim 2, wherein said first and second conductors are cylindrically shaped and coaxial.

4. The adapter enhancement of claim 2, wherein said first and second conductors are cylindrically shaped and not coaxial.

5. The adapter enhancement of claim 1, further comprising a second insulator affixed to said second conductor.

6. The adapter enhancement of claim 5, wherein said second insulator is comprises an opening having an inner surface, said second conductor being affixed to said inner surface of said opening of said second insulator.

7. The adapter enhancement of claim 1, wherein said first and second conductors are metal.

8. The adapter enhancement of claim 1, wherein said first insulator is plastic.

9. An electrical connector comprising
a first insulator, wherein said first insulator is substantially ring shaped and comprises an inner circumferential surface and an outer circumferential surface;
an inner substantially cylindrical conductor, wherein an outer surface of said inner conductor is affixed to said inner circumferential surface of said first insulator; and
an outer substantially cylindrical conductor, wherein an inner surface of said outer conductor is affixed to said outer circumferential surface of said first insulator.

10. The electrical connector of claim 9, wherein said inner and outer conductors are electrically insulated from one another.

11. The electrical connector of claim 9, further comprising a second insulator, wherein said second insulator is substantially ring shaped and comprises an opening having an inner surface affixed to said outer surface of said outer conductor.

12. The electrical connector of claim 9, wherein said inner an outer conductors are electrically insulated from one another.

13. The electrical connector of claim 11, wherein said first and second insulators are plastic.

14. The electrical connector of claim 9, wherein said adapter enhancement provides a secure electrical connection between an electronic device and an AC adapter.

15. The electrical connector of claim 9, wherein said outer conductor is segmented into a number of portions separated by free space.

16. The electrical connector of claim 15, further comprising a lever connected to one or more of said number of portions of said outer conductor.

17. The electrical connector of claim 16, wherein said lever can be positioned into a locked position, said locked position forcing said one or more or said number of portions of said outer conductor connected to said lever inward toward a cylindrical axis of said outer conductor.

18. The electrical connector of claim 9, wherein said inner conductor is segmented into a number of portions separated by free space.

19. A method comprising the steps of:
placing an adapter enhancement over an electrical device end of an AC adapter; and
inserting said AC adapter electrical device end with said adapter enhancement into an electrical port of an electrical device, wherein said adapter enhancement provides a secure electrical connection between said electronic device and said AC adapter.

20. The method of claim 19, further comprising the step of:
locking said adapter enhancement into said electrical port by positioning a lever affixed to said adapter enhancement into a locked position.
